(19) United States
(12) Patent Application Publication
(10) Pub. No.: US 2017/0015957 A1
(43) Pub. Date: Jan. 19, 2017

(54) Remnant Soap Melting and Shaping Assembly

(71) Applicant: Ronald Jones, Jacksonville, FL (US)

(72) Inventor: Ronald Jones, Jacksonville, FL (US)

(21) Appl. No.: 14/802,227

(22) Filed: Jul. 17, 2015

(51) Int. Cl. C11D 13/16; C11D 13/30

(52) U.S. Cl. CPC C11D 13/16; C11D 13/30

(57) ABSTRACT

A remnant soap melting and shaping assembly includes a housing including a bottom wall, a top wall and a perimeter wall attached to and extending between the top and bottom walls. The perimeter wall have a break therein dividing the housing into a base including the bottom wall and a cover including the top wall. The cover is movable between an open position and a closed position with respect to the base. A heating element is positioned within the housing adjacent to the bottom wall. A container is removably positioned in the housing and is positionable on the heating element. The heating element heats the container and melt soap positioned in the container. An inner lid is attached to an inside surface of the cover and has a perimeter edge that is mated with an upper edge of the container when the cover is placed in the closed position.

### BACKGROUND OF THE DISCLOSURE

### Field of the Disclosure

The disclosure relates to remnant soap melting devices and more particularly pertains to a new remnant soap melting device for melting a plurality of remnant soap bars into a single soap bar.

### SUMMARY OF THE DISCLOSURE

An embodiment of the disclosure meets the needs presented above by generally comprising a housing including a bottom wall, a top wall and a perimeter wall attached to and extending between the top and bottom walls. The perimeter wall have a break therein dividing the housing into a base including the bottom wall and a cover including the top wall. The cover is movable between an open position and a closed position with respect to the base. A heating element is positioned within the housing adjacent to the bottom wall. A container is removably positioned in the housing and is positionable on the heating element. The heating element heats the container and melt soap positioned in the container. An inner lid is attached to an inside surface of the cover and has a perimeter edge that is mated with an upper edge of the container when the cover is placed in the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a remnant soap melting and shaping assembly according to an embodiment of the disclosure.

FIG. 2 is a top perspective view of an embodiment of the disclosure.

FIG. 3 is a bottom view of an embodiment of the disclosure.

FIG. 4 is a cross-sectional view of an embodiment of the disclosure taken along line 4-4 of FIG. 3.

FIG. 5 is a side view of an embodiment of the disclosure.

FIG. 6 is a schematic view of an embodiment of the disclosure.

### DESCRIPTION OF THE PREFERRED EMBODIMENT

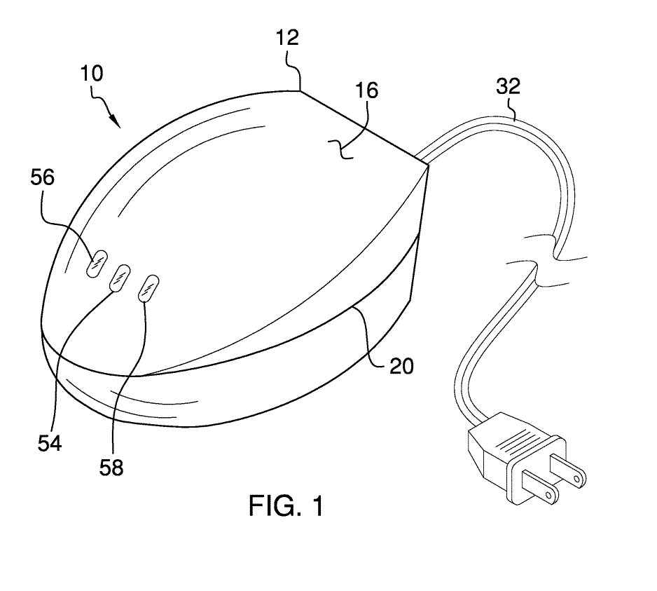

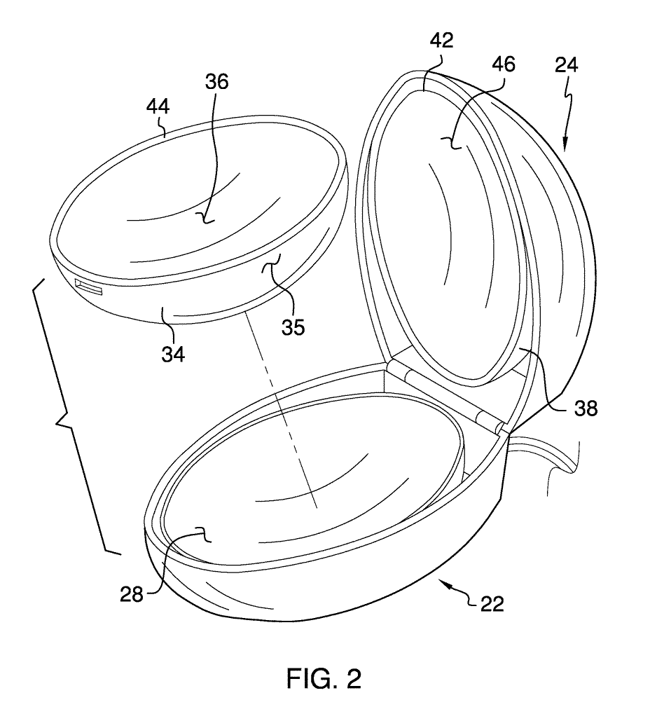

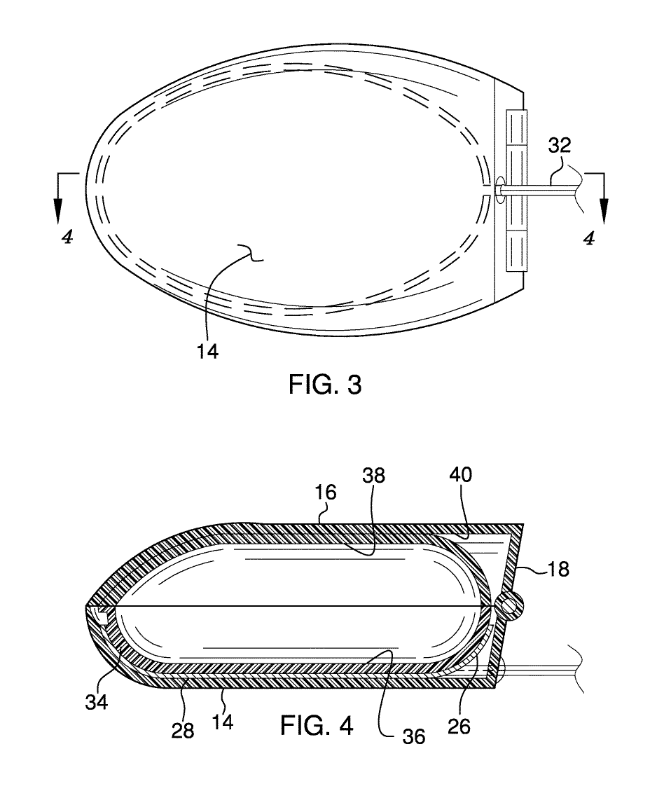

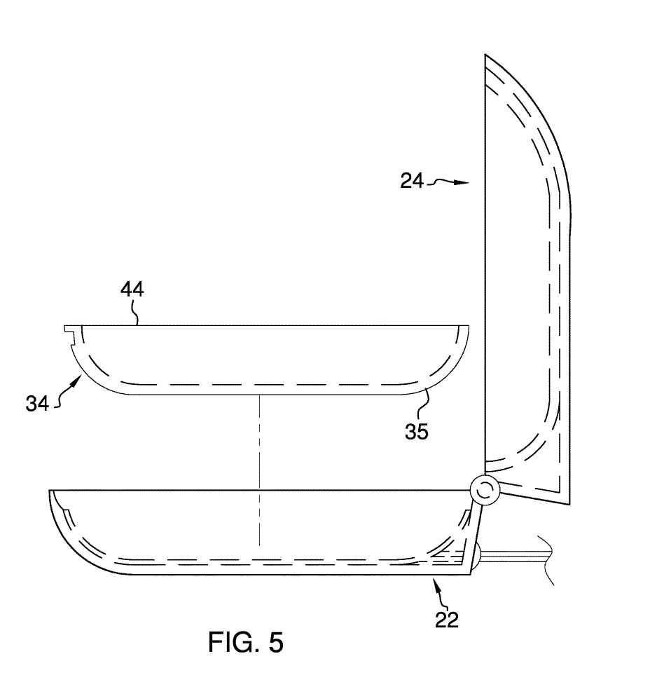

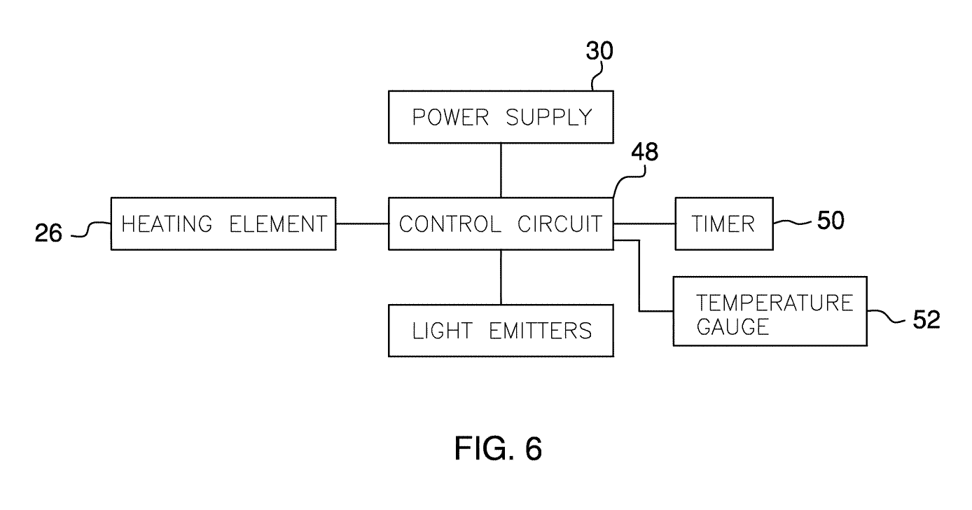

With reference now to the drawings, and in particular to FIGS. 1 through 6 thereof, a new remnant soap melting device embodying the principles and concepts of an embodiment of the disclosure and generally designated by the reference numeral 10 will be described.

As best illustrated in FIGS. 1 through 6, the remnant soap melting and shaping assembly 10 generally comprises a housing 12 including a bottom wall 14, a top wall 16 and a perimeter wall 18 that is attached to and extends between the top 16 and bottom 14 walls. The perimeter wall 18 has a break 20 therein dividing the housing 12 into a base 22 including the bottom wall 14 and a cover 24 including the top wall 16. The cover 24 and the base 22 are hingedly coupled together to allow the cover 24 to be moved between an open position and a closed position.

A heating element 26 is positioned within the housing 12 adjacent to the bottom wall 14. The heating element 26 produces a temperature of between 120° F. and 160° F. when the heating element is turned on. The heating element 26 may have a concavely shaped upper surface 28. A power supply 30 is electrically coupled to the heating element 26 for the purpose of providing power to the heating element 26. The power supply 30 may comprise a battery or may comprise a power cord 32 as shown in FIG. 1. The power cord would be configured to be plugged into a conventional female electrical outlet to supply electricity to the heating element 26.

A container 34 is removably positioned in the housing 12. The container 34 is positionable on the heating element 26 and the heating element 26 is configured to heat the container 34 and to melt any soap remnants positioned in the container. The container 34 has a convexly shaped bottom side 35 that conforms to a shape of the heating element 26. The container 34 has a concavely shaped top side 36. The container 34 may be elongated in one direction and have an overall length between 2.5 inches and 4.0 inches and a width between 2.0 inches and 3.0 inches. An inner lid 38 is attached to an inside surface 40 of the cover 24. The inner lid 38 has a perimeter edge 42 that is mated with an upper edge 44 of the container 34 when the cover 24 is placed in the closed position to prevent overflow of material out of the container 34 and into the base 22. The inner lid 38 has a facing surface 46 facing the container 34 wherein the facing surface 46 may be concavely arcuate.

A control circuit 48, or processor, is electrically coupled to the power cord 32 and the heating element 26. The control circuit 48 retains the heating element 26 in a powered condition for a preselected amount of time and turning off the heating element 26 after the preselected amount of time has elapsed. This preselected time may generally be between 5 minutes and 15 minutes. This may be accomplished with an electronic timer 50 coupled to the control circuit 48 or a timing program. The control circuit 48 may also include a temperature gauge 52 in thermal communication with the heating element. A light emitter 54 may be mounted on the housing 12 and is electrically coupled to the control circuit 48. The light emitter 54 is turned on when the temperature gauge 52 detects the heating element 26 has attained a predetermined temperature sufficient to melt soap. The predetermined temperature may be at least 120° F. The light emitter may include a plurality of light emitters, which may comprise light emitting diodes, wherein one of the light emitters defines a ready light 54 signaling the heating element 26 is sufficiently hot, one of the light emitters defines a power light 56 indicating that the heating element 26 is being powered, and one of the light emitters defines a finished light 58 indicating that the heating element 26 has been on for a predetermined amount of time which may be between 4 minutes and 10 minutes.

In use, a plurality of soap remnants is placed in the container 34, which is removable to allow it to be placed in a convenient place for receiving the remnants. The heating element 26 is then powered and the container 34 is placed on the heating element 26, either before or after the heating element 26 has reached the predetermined temperature. Once the heating element 26 has reached a pre-determined temperature as measured by the temperature gauge 52, the ready light 54 will turn on and the timer will start to provide power to the heating element 26 for a preselected amount of time after which the control circuit 48 may be programmed or structured to turn of the heating element 26 and turn on the finished light 58. Alternatively, the assembly 10 may contain no temperature gauge 52 wherein the ready light 54 activation, finished light 58 activation and power to the heating element 26 are each solely based on a length of time that power has been supplied to the heating element 26. A power switch, not shown, may further be in electrical communication with the power supply 30 to selectively turn the assembly 10 on or off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A soap remnant melting and reshaping assembly comprising:
a housing including a bottom wall, a top wall and a perimeter wall being attached to and extending between said top and bottom walls, said perimeter wall having a break therein dividing said housing into a base including said bottom wall and a cover including said top wall, said cover being movable between an open position and a closed position with respect to said base;
a heating element being positioned within said housing adjacent to said bottom wall;
a container being removably positioned in said housing, said container being positionable on said heating element, said heating element being configured to heat said container and melt soap positioned in said container; and
an inner lid being attached to an inside surface of said cover, said inner lid having a perimeter edge being mated with an upper edge of said container when said cover is placed in said closed position.

2. The soap remnant melting and reshaping assembly according to claim 1, wherein said cover and said base are hingedly coupled.

3. The soap remnant melting and reshaping assembly according to claim 1, wherein said heating element produces a temperature of between 120° F. and 160° F. when said heating element is turned on.

4. The soap remnant melting and reshaping assembly according to claim 1, wherein said heating element has a concavely shaped upper surface.

5. The soap remnant melting and reshaping assembly according to claim 1, further including a power cord being electrically coupled to said heating element, said power cord being configured to be plugged into a female electrical outlet to supply electricity to said heating element.

6. The soap remnant melting and reshaping assembly according to claim 4, wherein said container having a convexly shaped bottom side and conforming to a shape of said heating element, said container having a concavely shaped top side.

7. The soap remnant melting and reshaping assembly according to claim 5, further including a control circuit being electrically coupled to said power cord and said heating element, said control circuit retaining said heating element in a powered condition for a preselected amount of time and turning off said heating element after said preselected amount of time has elapsed.

8. The soap remnant melting and reshaping assembly according to claim 7, further including:
said control circuit including a temperature gauge in thermal communication with said heating element; and
a light emitter being mounted on said housing and being electrically coupled to said control circuit, said light emitter being turned on when said temperature gauge detects said heating element has attained a predetermined temperature sufficient to melt soap.

9. A soap remnant melting and reshaping assembly comprising:
a housing including a bottom wall, a top wall and a perimeter wall being attached to and extending between said top and bottom walls, said perimeter wall having a break therein dividing said housing into a base including said bottom wall and a cover including said top wall, said cover and said base being hingedly coupled together to allow said cover to be moved between an open position and a closed position;
a heating element being positioned within said housing adjacent to said bottom wall, said heating element producing a temperature of between 120° F. and 160° F. when said heating element is turned on, said heating element having a concavely shaped upper surface;
a power cord being electrically coupled to said heating element, said power cord being configured to be plugged into a female electrical outlet to supply electricity to said heating element;
a container being removably positioned in said housing, said container being positionable on said heating element, said heating element being configured to heat said container and melt soap positioned in said container, said container having a convexly shaped bottom side and conforming to a shape of said heating element, said container having a concavely shaped top side;
a control circuit being electrically coupled to said power cord and said heating element, said control circuit retaining said heating element in a powered condition for a preselected amount of time and turning off said heating element after said preselected amount of time has elapsed, said control circuit including a temperature gauge in thermal communication with said heating element;
a light emitter being mounted on said housing and being electrically coupled to said control circuit, said light emitter being turned on when said temperature gauge detects said heating element has attained a predetermined temperature sufficient to melt soap; and
an inner lid being attached to an inside surface of said cover, said inner lid having a perimeter edge being mated with an upper edge of said container when said cover is placed in said closed position, said inner lid having a facing surface facing said container, said facing surface being concavely arcuate.
